(19) United States
(12) Patent Application Publication
(10) Pub. No.: US 2009/0171794 A1
(43) Pub. Date: Jul. 2, 2009

(54) SYSTEMS AND METHODS FOR PROCESSING A PAYMENT TRANSACTION

(76) Inventors: Peter P. Hogan, O'Fallon, MO (US); George J. Spies, Ft. Meyers, FL (US)

Correspondence Address: DANIEL M. FITZGERALD (21652);ARMSTRONG TEASDALE LLP, ONE METROPOLITAN SQUARE, SUITE 2600, ST. LOUIS, MO, 63102-2740, US

(21) Appl. No.: 11/965,516

(22) Filed: Dec. 27, 2007

(51) Int. Cl. G06Q 20/00

(52) U.S. Cl. 705/17

(57) ABSTRACT

Systems and methods for point of sale instant access are provided. In one aspect, a method for processing a payment transaction in real time is provided. The method uses a server system coupled to an input device, the input device is located at a point of sale (POS) of a merchant. The input device includes an Internet protocol (IP) address. The method includes capturing at the input device transaction data including an account number associated with a payment card used in the transaction and other information relating to the transaction, and receiving at the server system, directly from the input device, the transaction data. The method also includes processing, at the server system, the transaction data including determining whether to authorize the transaction, and communicating, directly from the server system to the input device, one of an authorization of the transaction and a denial of the transaction.

### BACKGROUND OF THE INVENTION

This invention relates generally to systems and methods for processing a payment transaction and, more particularly, to a system and method for electronically processing, in real-time, a payment transaction at a point of sale that is connected to a remote processing system via a network.

Many credit card customers receive rewards, such as frequent flyer points, gift certificates, or cash back as an incentive to use the card. Rewards are generally tied to purchasing an item or service using the card. Rewards may also be provided to the cardholder when the card is used for balance transfers, cash advances, or other special uses. Depending on the type of card, rewards will generally cost the card issuer a percentage of the transaction amount. Most rewards points are accrued as a liability on a company's balance sheet and expensed at the time of reward redemption. As a result, some issuers discourage redemption by forcing the cardholder to call customer service for rewards. Alternatively, while a cardholder may often redeem rewards points through an issuer's website, reward redemption is usually a feature that is very well hidden by the issuers. At least some issuers encourage redemption, but for lower cost merchandise. For example, instead of an airline ticket, which may be quite expensive to an issuer, the issuer of a card may encourage the cardholder to redeem their rewards points for a gift certificate which is less costly to the issuer.

Moreover, at least some known financial payment systems require transaction information to be communicated between many entities. For example, when a cardholder tenders payment for a purchase with a financial transaction card, such as a credit card or a debit card, the merchant requests authorization from the merchant bank for the amount of the purchase. The merchant bank then communicates with the computers of an issuer bank to determine whether the cardholder's account is in good standing and whether the purchase is covered by the cardholder's available credit line. Based on these determinations, the request for authorization will be declined or accepted. If the request is accepted, an authorization code is issued to the merchant. After a transaction is captured, the transaction is cleared, e.g., sufficient funds in the cardholder's account are identified and debited by the issuer. The transaction is then settled, e.g., payment data is recorded, between the merchant, the merchant bank, and the issuer.

While transaction information, such as authorization and settlement information, is communicated between many parties for each transaction, information such as rewards points are not communicated between the issuer and the merchant in a timely manner, wherein a cardholder is able to use their rewards points at the point of sale. Accordingly, a system that enables a cardholder to access and use, in real time, rewards points or other special offers, provided by the issuer and/or merchant at the point of sale, is needed.

### BRIEF DESCRIPTION OF THE INVENTION

In one aspect, a method for processing a payment transaction in real time is provided. The method uses a server system coupled to an input device, the input device is located at a point of sale (POS) of a merchant. The input device includes an Internet protocol (IP) address. The method includes capturing at the input device transaction data including an account number associated with a payment card used in the transaction and other information relating to the transaction, and receiving at the server system, directly from the input device, the transaction data. The method also includes processing, at the server system, the transaction data including determining whether to authorize the transaction, and communicating, directly from the server system to the input device, one of an authorization of the transaction and a denial of the transaction.

In another aspect, a network-based system for real-time processing of a payment transaction is provided. The system includes an input device located at a merchant point of sale (POS), wherein the input device has an Internet protocol (IP) address and is configured to capture transaction data including an account number associated with a payment card used in the transaction and other information relating to the transaction. The system also includes a database for storing information and a server system configured to be coupled to the input device and the database. The server system is configured to receive the transaction data directly from the input device, process the transaction data including determining whether to authorize the transaction, and communicate, directly to the input device, one of an authorization of the transaction and a denial of the transaction.

In another aspect, a computer for real-time processing of a payment transaction is provided. The computer is coupled to a database. The payment transaction is performed by a cardholder using a payment card over a payment card network. The computer is in communication with an input device located at a merchant point of sale (POS), wherein the input device includes an Internet protocol (IP) address. The computer is programmed to receive transaction data directly from the input device, the transaction data captured by the input device and including an account number associated with a payment card used in the transaction and other information relating to the transaction. The computer is also programmed to process the transaction data including determining whether to authorize the transaction and communicate, directly to the input device, one of an authorization of the transaction and a denial of the transaction.

In a further aspect, a computer program embodied on a computer readable medium for processing a payment transaction is provided. The payment transaction is processed using a point of sale (POS) input device, the input device having an assigned Internet protocol (IP) address enabling the input device to communicate with a remote server system. The computer program includes at least one code segment that captures transaction data including an account number associated with a card used in the transaction and other information relating to the transaction, and communicates, directly from the input device to the server system, the transaction data. The code segment also processes the transaction data including determining whether to authorize the transaction and communicates, directly from the server system to the input device, one of an authorization of the transaction and a denial of the transaction.

### BRIEF DESCRIPTION OF THE DRAWINGS

FIG. 1 is a flowchart illustrating a typical financial transaction using a financial transaction card payment system.

FIG. 2 is a simplified block diagram of an exemplary embodiment of a server architecture of a system in accordance with one embodiment of the present invention.

FIG. 3 is an expanded block diagram of an exemplary embodiment of a server architecture of a system in accordance with one embodiment of the present invention.

FIG. 4 is a flowchart illustrating exemplary methods utilized by the system shown in FIG. 3.

### DETAILED DESCRIPTION OF THE INVENTION

As used herein, an acquiring bank is typically a bank at which a merchant holds an account. In addition, an issuing bank is typically a bank at which a customer holds an account, which may be debited through the use of a credit card, debit card, or pre-paid debit card. In at least some cases, the acquiring bank and the issuing bank may be the same entity.

As used herein, a processor may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term processor.

Described in detail herein are exemplary embodiments of systems and methods that facilitate processing a payment transaction in real time. The systems and methods facilitate, for example, communicating transaction and payment card account data electronically, and directly, between a point of sale (POS) device and a transaction processing system that may include or may further communicate with a rewards processing system. As a result, the systems and methods described herein enable a customer, and a cardholder, to access and use rewards points or other special offers provided by the card issuer in real time at the POS, as opposed to accumulating rewards points until a certain level is reached at which point a gift certificate or other reward is mailed to the cardholders

A technical effect of the systems and methods described herein include at least one of (a) electronically reading or capturing an account number from a payment card used in a financial transaction using a point of sale input device having an Internet protocol (IP) address enabling the input device to communicate with a remote server system over a network; (b) transmitting the account number and additional transaction-related information, including a transaction amount, directly from the input device to the server system; (c) querying the server system for information relating to a balance of an account associated with the account number captured from the payment card, wherein the account may be a credit account, a debit account, a pre-paid debit account, and/or a rewards point account; (d) prompting the cardholder to use rewards points to pay at least a portion of the transaction amount; (e) comparing the transaction amount to the account balance to either authorize the transaction, wherein the account balance may be the currently balance of a debit account, a pre-paid debit account, a rewards points account, or a credit account; (f) further querying the server system for a current offer applicable to transactions occurring at the merchant and prompting the cardholder to accept or deny the offer; and (g) communicating directly from the server system to the input device either an authorization of the transaction and a denial of the transaction.

In one embodiment, a computer program is provided, and the program is embodied on a computer readable medium and utilizes a Structured Query Language (SQL) for communications between an end user device, such as an input device at a merchant point of sale (POS) terminal, and a remote server system that is coupled to communicate with a database. In an exemplary embodiment, such a system is run on a business-entity intranet. In another embodiment, such a system is run on a combination of one or more business-entity intranets as well as on the Internet.

The systems and methods described herein are not limited to the specific embodiments described herein. For example, components of each system and each method may be practiced independent and separate from other components and methods described herein. In addition, each component and method may also be used in combination with other assembly packages and methods.

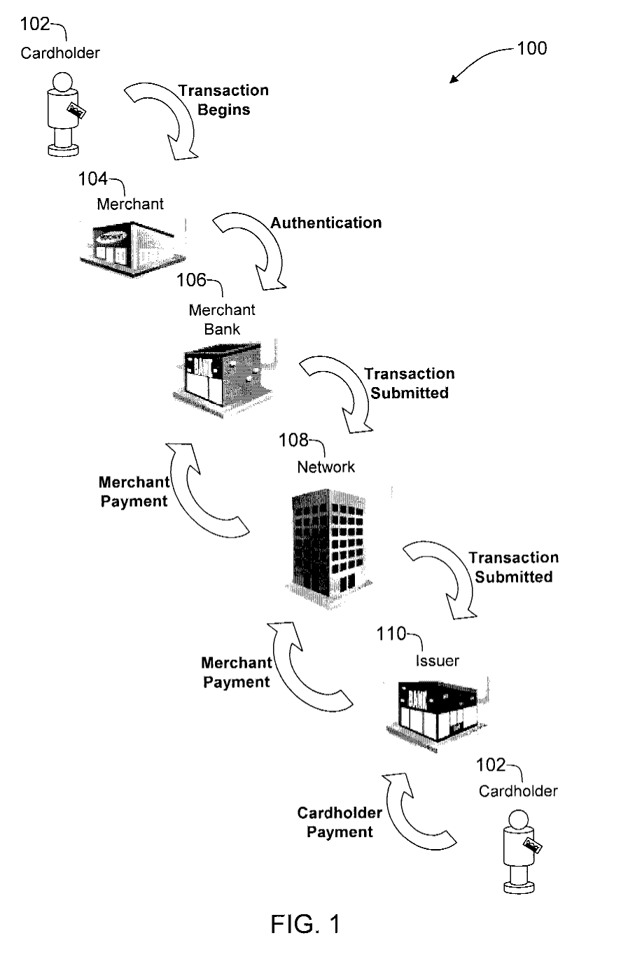

FIG. 1 is a flowchart that illustrates a typical financial transaction 100 using a financial transaction card payment system. More specifically, financial transaction 100 shown in FIG. 1 represents a credit card payment transaction, such as a credit card payment system using the MasterCard® interchange (MasterCard is a registered trademark of MasterCard International Incorporated, Purchase, New York). The MasterCard® interchange is a proprietary communications network promulgated by MasterCard International Incorporated® for the exchange of financial transaction data between financial institutions that are members of MasterCard International Incorporated®. The present invention relates to an input device that is used by a customer at a merchant point of sale (POS), wherein the input device connects directly to a remote server system to process the transaction. The input device includes a network interface, which enables the input device to be assigned an internet protocol (IP) address. The network interface thereby enables the input device to connect and communicate with the server system over a network, such as the Internet.

In a typical financial payment system, a financial institution called the “issuer” issues a financial transaction card, such as a credit card, debit card, or a pre-paid debit card, to a consumer, who uses the financial transaction card to tender payment for a purchase from a merchant. To accept payment with the financial transaction card, the merchant must normally establish an account with a financial institution that is part of the financial payment system. This financial institution is usually called the “merchant bank” or the “acquiring bank” or “acquirer bank.” When a cardholder 102 tenders payment for a purchase with a financial transaction card, the merchant 104 requests authorization from the merchant bank 106 for the amount of the purchase. The request may be performed over the telephone, but is usually performed through the use of a point of sale (POS) terminal, which reads the cardholder's account information from the magnetic stripe on the financial transaction card and communicates electronically with the transaction processing computers of the merchant bank using a private, dedicated network. Alternatively, a merchant bank may authorize a third party to perform transaction processing on its behalf. In such a case, the POS terminal is configured to communicate with the third party. Such a third party is usually called a “merchant processor” or an “acquiring processor.”

Using the interchange 108, the computers of merchant bank 106 or the merchant processor will communicate with the computers of an issuer bank 110 to determine whether a cardholder's account 112 is in good standing and whether the purchase is covered by the cardholder's available credit line. Based on these determinations, the request for authorization will be declined or accepted. If the request is accepted, an authorization code is issued to merchant 104.

When a request for authorization is accepted, the available credit line of cardholder's account 112 is decreased. Normally, a charge is not posted immediately to consumer's account 112 because bankcard associations, such as MasterCard International Incorporated®, have promulgated rules that do not allow merchant 104 to charge, or “capture,” a transaction until goods are shipped or services are delivered. When merchant 104 ships or delivers the goods or services, merchant 104 captures the transaction by, for example, appropriate data entry procedures on the point-of-sale terminal. If cardholder 102 cancels a transaction before it is captured, a “void” is generated. If cardholder 102 returns goods after the transaction has been captured, a “credit” is generated.

After a transaction is captured, the transaction is settled between merchant 104, merchant bank 106, and the issuer 110. Settlement refers to the transfer of financial data or funds between the merchant's account, merchant bank 106, and issuer 110 related to the transaction. Usually, transactions are captured and accumulated into a “batch,” which are settled as a group.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, and radio frequency identification (RFID) devices.

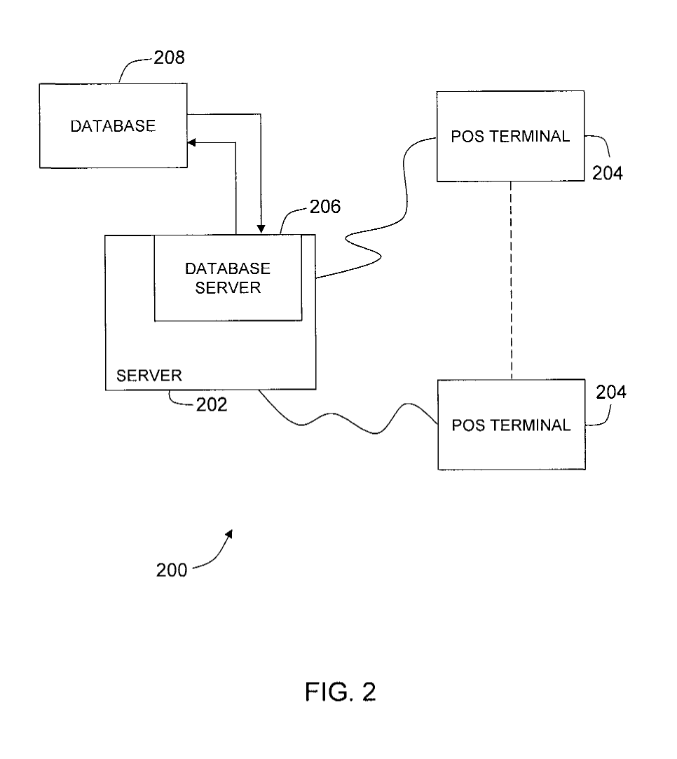

FIG. 2 is a simplified block diagram of an exemplary system 200 in accordance with one embodiment of the present invention. In one embodiment, system 200 is a payment card system used for implementing payment transaction processing in real-time such that a cardholder may choose to utilize accumulated reward points at the point of a purchase. In another embodiment, system 200 is a payment card system, which can be utilized by account holders to process a purchase as a normal credit, debit, or pre-paid transaction while bypassing the multiple communication layers that are normally required to complete a transaction.

More specifically, in the example embodiment, system 200 includes a server system 202, and a plurality of point of sale (POS) terminals 204, connected to server system 202. In one embodiment, POS terminals 204 each include a network interface such that each POS terminal 204 may be assigned an Internet protocol (IP) address, such that each POS terminal 204 is accessible by server system 202 over the Internet and each POS terminal 204 is able to communicate directly with server system 202. In an alternative embodiment, POS terminals 204 are configured to be accessible by server system 202 through a gateway server located at the merchant. The gateway server is configured to receive transaction data from POS terminals 204 and to push the information to server system 202. POS terminals 204 are interconnected to the Internet through many interfaces including a network, such as a local area network (LAN) or a wide area network (WAN), dial-in-connections, cable modems, wireless modems, and special high-speed ISDN lines. POS terminals 204 could be any device capable of interconnecting to the Internet and including an input device capable of reading information from a consumer's financial transaction card. A database server 206 is connected to a database 208 containing information on a variety of matters, as described below in greater detail. In one embodiment, centralized database 208 is stored on server system 202 and may be accessed by POS terminals 204. In an alternative embodiment, database 208 is stored remotely from server system 202 and may be non-centralized.

As discussed below, database 208 stores transaction data generated as part of sales activities conducted over the bankcard network including data relating to merchants, account holders or customers, and purchases. Database 208 further includes data relating to rewards programs and special offers including processing codes and business rules associated with the different rewards programs and special offers.

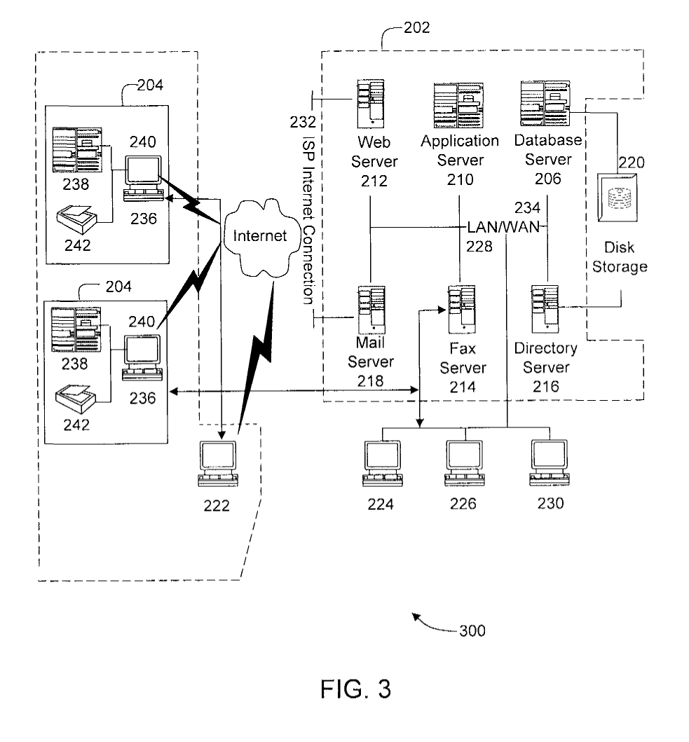

FIG. 3 is an expanded block diagram of an exemplary embodiment of a server architecture of a system 300 in accordance with one embodiment of the present invention. Components in system 300, identical to components of system 200 (shown in FIG. 2), are identified in FIG. 3 using the same reference numerals as used in FIG. 2. System 300 includes server system 202 and POS terminals 204. Server system 202 further includes database server 206, an application server 210, a web server 212, a fax server 214, a directory server 216, and a mail server 218. A disk storage unit 220 is coupled to database server 206 and directory server 216. Servers 206, 210, 212, 214, 216, and 218 are coupled in a local area network (LAN) 220. In alternative embodiments, system 300 may include a user workstation 224 and/or a supervisor's workstation 226 each coupled to LAN 228. Alternatively, workstations 224 and 226 are coupled to LAN 228 using an Internet link or are connected through an Intranet.

Each workstation 224 and 226 is a personal computer having a web browser. Although the functions performed at the workstations typically are illustrated as being performed at respective workstations 224 and 226, such functions can be performed at one of many personal computers coupled to LAN 228. Workstations 224 and 226 are illustrated as being associated with separate functions only to facilitate an understanding of the different types of functions that can be performed by individuals having access to LAN 228.

Server system 202 is configured to be communicatively coupled to various entities, including POS terminals 204 and to third parties, e.g., merchant servers, acquiring bank servers, etc., 230 using an ISP Internet connection 232. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 234, local area network 228 could be used in place of WAN 234.

Each POS terminal 204 includes a network interface 236 that enables POS terminal 204 to communicate with server system 202 via a network, such as the Internet. Alternatively, network interface 236 may enable each POS terminal 204 to communicate with server system 202 via a private network, such as LAN 228 and/or WAN 234. In addition, each POS terminal 204 includes one or more processors 238, a display 240 for interacting with a cardholder, and a card reader 242. In one embodiment, a gateway server 222 is electronically coupled to each POS terminal 204 via a network. Gateway server 222 may be located on the premises of a merchant or, alternatively, may be located at an acquiring bank. Gateway server 222 is also electrically coupled to server system 202.

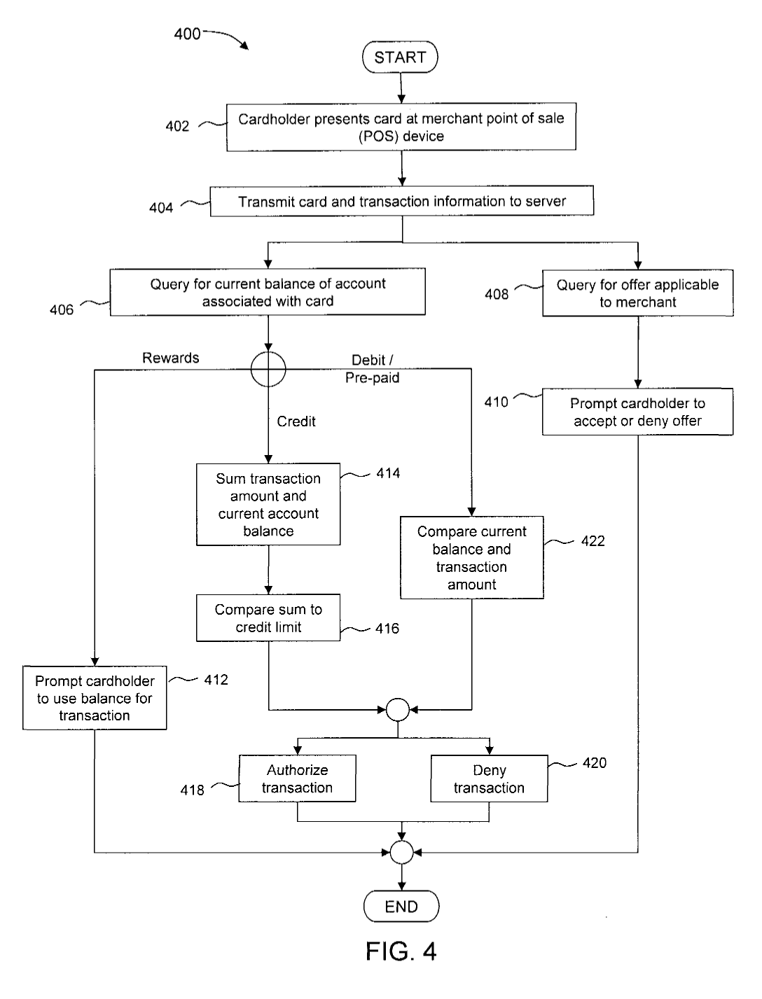

FIG. 4 is a flowchart illustrating exemplary methods utilized by system 300 (shown in FIG. 3). In the exemplary embodiment, system 300 may be utilized by any one of an issuing bank that issues a financial transaction card, a cardholder who uses a financial transaction card to tender payment for a purchase from a merchant, a merchant that sells a product, an acquiring bank, and a financial transaction card network or interchange for processing a financial transaction.

In the exemplary embodiment, and referring to FIGS. 2 and 3, system 300 facilitates processing a financial transaction between a cardholder and a merchant when the cardholder presents 402 the payment card to the merchant for payment. The payment card may include a credit card, a debit card, or a pre-paid debit card. In addition, the payment card, also referred to as a financial transaction card, may be associated with a rewards program, wherein the cardholder is eligible for rewards based on purchases completed using the financial transaction card. An example of a rewards program is a rewards point account associated with the financial transaction card, wherein server system 202 tracks and records the rewards points for the account. When the cardholder presents 402 the payment card for payment, the cardholder or a merchant employee swipes the card through an input device located at a merchant point of sale (POS) terminal 204. When a cardholder swipes a financial transaction card through card reader 242, processor 238 reads an account number from a magnetic strip located on the card. In an alternative embodiment, processor 238 reads the account number from a device, such as a key fob or an RFID device. A technical effect of the methods and systems described herein is achieved by transmitting 404 information relating to the financial transaction card and the financial transaction to server system 202. In the exemplary embodiment, POS terminal 204 transmits 404 the account number and a transaction amount to server system 202. In an alternative embodiment, POS terminal 204 transmits 404 the account number and a transaction amount to gateway server 222, which then transmits the same information to server system 202. Gateway server 222 functions as a conduit for account and transaction information between each POS terminal 204 and server system 202.

Server system 202, upon receiving the account number and transaction information from POS terminal 204 or, alternatively, gateway server 222, queries 406 database 208 for a current balance of the account associated with the account number. The account may be a rewards account, a credit account, a debit account, or a pre-paid debit account. If the account is a rewards account, the current balance is a current number of rewards points available for use. If the account is a credit account, the current balance is a current principal balance owed on the account by the cardholders If the account is a debit account, the current balance is an amount of money currently available for use in the cardholder's debit account. Similarly, if the account is a pre-paid debit account, the current balance is an amount of pre-paid money currently available for use in the cardholder's pre-paid debit account. Alternatively, the transaction information transmitted to server system 202 may include a merchant identifier. Server system 202 queries 408 database 208 for a list of offers applicable to transactions occurring at the identified merchant. For example, a transaction occurring at a particular merchant and having a transaction amount greater than a predetermined amount may be paid for with no interest if the transaction amount is paid in full before a predetermined date. Resulting offers are returned to POS terminal 204 and displayed for the cardholders POS terminal display 240 prompts 410 the cardholder to either accept or deny the offer prior to completion of the transaction.

In one embodiment, a cardholder may wish to redeem rewards points at POS terminal 204 in order to pay at least a portion of the transaction amount. After server system 202 queries 406 database 208 for a number of accumulated rewards points currently available for use, the number of rewards points is returned to POS terminal 204 and displayed for the cardholders The cardholder is prompted 412 to pay at least a portion of the transaction amount using the current number of rewards points or to pay the transaction amount using another payment method. If the cardholder elects to use the current number of rewards points to pay the transaction amount, the transaction amount is debited from the current number of rewards points. Alternatively, server system 202 compares the current number of rewards points with the transaction amount and prompts 412 the cardholder to use the rewards points to pay the transaction amount only if the current number of rewards points is equal to or greater than the transaction amount. The rewards points account balance is then debited by the transaction amount.

In another embodiment, a cardholder may wish to pay the transaction amount at POS terminal 204 with a credit card. After server system 202 queries 406 database 208 for a current credit balance, server system 202 calculates 414 the sum of the current credit balance and the transaction amount. The sum is then compared 416 to an account credit limit. Based on the comparison, the payment transaction is either authorized 418 or denied 420. Specifically, if the sum is less than or equal to the credit limit, the transaction is authorized 418 and the transaction amount is added to the current credit balance. Alternatively, if the sum is greater than the credit limit, then the transaction is denied 420.

In another embodiment, a cardholder may wish to pay the transaction amount at POS terminal 204 with a debit card or with a pre-paid debit card. After server system 202 queries 406 database 208 for a current account balance, server system 202 compares 422 the current available balance and the transaction amount. If the current available balance is greater than or equal to the transaction amount, the transaction is authorized 418 and the account is debited by the transaction amount. Alternatively, if the current available balance is less than the transaction amount, the transaction is denied 420. In a further alternative embodiment, the cardholder may be given the choice of whether to re-load a pre-paid debit card at POS terminal 204, using either a credit card or a debit card. In such an embodiment, server system 202 queries 406 database 208 for a current account balance. A sum is calculated 414 of the amount the cardholder wishes to load to the pre-paid debit card and the current balance, and the sum and credit limit are compared 416. If the sum is less than or equal to the credit limit, the transaction is authorized 418. Alternatively, if the sum is greater than the credit limit, then the transaction is denied 420. Similarly, if the cardholder loads the pre-paid debit card using a debit card, the current balance is compared 422 to the amount the cardholder wishes to load to the pre-paid debit card. If the current balance is greater than or equal to the transaction amount, the transaction is authorized 418. Alternatively, if the current balance is less than the transaction amount, the transaction is denied 420.

The systems and methods described herein facilitate real time financial transaction processing by enabling a point of sale input device having an IP address to communicate directly with a transaction processing system, rather than communicating data between a larger number of entities. Moreover, the systems and methods described herein enable a cardholder to utilize accumulated rewards points during a transaction, rather than forcing the cardholder to request a reward using a telephone hotline or through a website hosted by the card issuer. Further, the systems and methods described herein enable a merchant and card issuer to offer a cardholder a discount or special financing at the time of the transaction, even if the cardholder was previously unaware of the offer and did not request the offer prior to the transaction.

Although the systems and methods described herein are described in the context of real time financial transaction processing and/or rewards redemption, it is understood that the systems and methods are not limited to only such systems and/or methods. Likewise, the system components illustrated are not limited to the specific embodiments herein, but rather, components of the system may be utilized independently and separately from other components described herein.

While the invention has been described in terms of various specific embodiments, those skilled in the art will recognize that the invention can be practiced with modification within the spirit and scope of the claims.

What is claimed is:

1. A method for processing a payment transaction in real time using a server system coupled to an input device, the input device is located at a point of sale (POS) of a merchant, the input device includes an Internet protocol (IP) address, said method comprising:
capturing at the input device transaction data including an account number associated with a payment card used in the transaction and other information relating to the transaction;
receiving at the server system, directly from the input device, the transaction data;
processing, at the server system, the transaction data including determining whether to authorize the transaction; and
communicating, directly from the server system to the input device, one of an authorization of the transaction and a denial of the transaction.

2. A method in accordance with claim 1 wherein receiving the transaction data at the server system comprises transmitting the transaction data from the input device to a gateway, the gateway configured to push the transaction data to the server system.

3. A method in accordance with claim 1 wherein processing the transaction further comprises determining a current balance of rewards points of a rewards account associated with the account number of the payment card.

4. A method in accordance with claim 3 wherein communicating one of an authorization and a denial further comprises:
transmitting the current rewards points balance directly from the server system to the input device, wherein the input device processes the transaction including payment by a customer of the merchant using a payment card;
prompting the customer to use at least a portion of the current rewards points balance for paying at least a portion of an amount of the transaction; and
debiting the current rewards points balance by an amount equal to the number of rewards points used in paying the transaction.

5. A method in accordance with claim 1 wherein processing the transaction further comprises determining a current offer applicable to transactions occurring at the identified merchant.

6. A method in accordance with claim 5 wherein communicating an authorization or a denial further comprises:
transmitting the current offer to the input device processing the transaction including payment by a customer of the merchant using a payment card; and
prompting the customer to one of accept and reject the offer.

7. A method in accordance with claim 1 wherein processing the transaction further comprises:
determining an available account balance of the account associated with a debit card, wherein the received account number is associated with a debit account held by a customer; and
comparing the available account balance with an amount of the transaction.

8. A method in accordance with claim 1 wherein processing the transaction further comprises:
determining a available account balance of the account associated with a pre-paid debit card, wherein the received account number is associated with a pre-paid debit account held by a customer;
comparing the available account balance with an amount of the transaction; and
generating one of an authorization code and a denial code based on the comparison.

9. A method in accordance with claim 8 further comprising prompting the customer to use the available account balance to pay at least a portion of the amount of the transaction, wherein the available account balance is less than the amount of the transaction.

10. A method in accordance with claim 1 wherein processing the transaction further comprises:
determining a current credit balance of the account associated with a credit card and a credit limit of the account associated with the credit card, wherein the received account number is associated with a credit account held by a customer;
calculating a sum of the current credit balance and an amount of the transaction; and
comparing the sum with the credit limit.

11. A network-based system for real-time processing of a payment transaction, said system comprising:
an input device located at a merchant point of sale (POS), said input device having an Internet protocol (IP) address, said input device configured to capture transaction data including an account number associated with a payment card used in the transaction and other information relating to the transaction;
a database for storing information; and
a server system configured to be coupled to said input device and said database, said server system configured to:
receive the transaction data directly from said input device;
process the transaction data including determining whether to authorize the transaction; and
communicate, directly to said input device, one of an authorization of the transaction and a denial of the transaction.

12. A system in accordance with claim 11 further comprising a gateway server configured to be coupled to said input device and said server system, said gateway server further configured to:
receive the transaction data from said input device; and
push the transaction data to said server system.

13. A system in accordance with claim 11 wherein said server system is further configured to query said database for a current balance of rewards points of a rewards account associated with the account number, said at least one input device is further configured to prompt the customer to use the current rewards points balance to pay at least a portion of an amount of the transaction.

14. A system in accordance with claim 11 wherein said server system is further configured to:
query said database for a current balance of rewards points of a rewards account associated with the account number;
compare the current rewards points balance to an amount of the transaction; and
communicate the current rewards points balance to said input device if the current rewards points balance is equal to or greater than the amount, said input device is configured to prompt the customer to use at least a portion of the current rewards points balance to pay the amount of the transaction.

15. A system in accordance with claim 11 wherein said input device is configured to communicate a merchant identifier to said server system, said server system is further configured to query said database for a current offer applicable to transactions occurring at the identified merchant.

16. A system in accordance with claim 11 wherein said server system is further configured to:
query said database for an available account balance of the account associated with the card used in the transaction, wherein the account is one of a debit account and a pre-paid debit account;
compare the available account balance with an amount of the transaction; and
one of authorize the transaction and deny the transaction based on the comparison.

17. A computer coupled to a database for real-time processing of a payment transaction performed by a cardholder using a payment card over a payment card network, the computer in communication with an input device located at a merchant point of sale (POS), the input device includes an Internet protocol (IP) address, said computer programmed to:
receive transaction data directly from the input device, the transaction data captured by the input device and including an account number associated with a payment card used in the transaction and other information relating to the transaction;
process the transaction data including determining whether to authorize the transaction; and
communicate, directly to the input device, one of an authorization of the transaction and a denial of the transaction.

18. A computer in accordance with claim 17 further programmed to:
query the database for a current balance of rewards points of a rewards account associated with the account number; and
communicate the current rewards points balance directly to the input device, wherein the input device processes the transaction and prompts the cardholder to use the current rewards points balance to pay at least a portion of an amount of the transaction.

19. A computer in accordance with claim 17 further programmed to:
query the database for a current offer applicable to transactions occurring at a merchant associated with the input device; and
communicate the offer to the input device, wherein the input device prompts the cardholder to one of accept and deny the offer.

20. A computer in accordance with claim 17 further programmed to:
query the database for an available account balance of the account associated with the payment card used in the transaction, wherein the account is one of a debit account and a pre-paid debit account; and
compare the available account balance with an amount of the transaction.

21. A computer program embodied on a computer readable medium for processing a payment transaction using a point of sale (POS) input device, the input device having an assigned Internet protocol (IP) address enabling the input device to communicate with a remote server system, said program comprising at least one code segment that:
captures transaction data including an account number associated with a card used in the transaction and other information relating to the transaction;
communicates, directly from the input device to the server system, the transaction data;
processes the transaction data including determining whether to authorize the transaction; and
communicates, directly from the server system to the input device, one of an authorization of the transaction and a denial of the transaction.

22. A computer program in accordance with claim 21 further comprising at least one code segment that:
communicates the transaction data from the input device to a gateway; and
communicates the transaction data from the gateway to the server system.

23. A computer program in accordance with claim 21 further comprising at least one code segment that:
determines a current balance of rewards points of a rewards account associated with the account number;
prompts the customer to use the current rewards points balance to pay at least a portion of an amount of the transaction; and
debits the current rewards points balance by an amount equal to the number of rewards points used in paying the transaction.

24. A computer program in accordance with claim 21 further comprising at least one code segment that determines a current offer applicable to transactions occurring at an identified merchant.

25. A computer program in accordance with claim 21 further comprising at least one code segment that:
determines an available account balance of the account associated with the card used in the transaction, wherein the account is one of a debit account and a pre-paid debit account; and
compares the available account balance with an amount of the transaction.
